(19) United States
(12) Patent Application Publication
(10) Pub. No.: US 2011/0145734 A1
(43) Pub. Date: Jun. 16, 2011

(54) Processing Computer Implemented Action

(75) Inventors: Henricus Johannes Maria Meijer, Mercer Island, WA (US); John Wesley Dyer, Monroe, WA (US)

(73) Assignee: Microsoft Corporation, Redmond, WA (US)

(21) Appl. No.: 12/634,703

(22) Filed: Dec. 10, 2009

(51) Int. Cl. G06F 3/00

(52) U.S. Cl. 715/762

(57) ABSTRACT

A method for processing a computer action using a processor. The method includes receiving a first request to perform a first computer action, performing the first computer action and producing a first class representation of the first computer action.

### BACKGROUND

Traditionally, certain computer functions are used to perform various computer implemented actions, such as adding an email address to a list server, ordering a product from an online merchant and the like. Some computer implemented actions are composite actions such that one computer implemented action causes additional computer implemented actions. For example, if a user uses a computer function to order roses, the computer function sends a request for the roses to a florist's computer system. Upon receiving the request for the roses, the florist's computer system invokes a florist's computer function to send a request to its supplier's computer system to ship more roses to the florist. The supplier's computer system consequently invokes a supplier's computer function to ship the roses to the florist. The subsequent computer implemented action of sending a request to the supplier's computer system is a composite action that is based on the initial request sent by the computer function to order the roses.

In operation, a first computer function sends a request to a second computer function to perform a first computer implemented action. The first computer function identifies itself to the second computer function using a first parameter (e.g., handler). When the second computer function receives the first computer function's request, the second computer function creates a second parameter (e.g., handler′) to identify the first computer function. The second computer function then creates a mapping to map the second parameter (e.g., handler′) to the first parameter (e.g., handler). The second computer function then invokes a third computer function by sending a request to the third computer function to perform a second computer implemented action. The second computer function also sends the second parameter (e.g., handler′) to the third computer function. When the third computer function receives the second computer function's request, the third computer function creates a third parameter (e.g., handler″) to identify the second computer function. The third computer function then creates a second mapping to map the second parameter (e.g., handler′) to the third computer function's parameter (e.g., handler″). In this manner, the first computer function's initial request for the first computer implemented action is identified by three different parameters in this composite system.

In order to cancel, undo or even keep track of the first computer implemented action and the subsequent computer implemented actions, the first computer function should be aware of the subsequent computer implemented actions that occur after the first computer implemented action and the corresponding parameters used for each subsequent computer implemented action. Currently, in order to undo the first computer implemented action, an undo function is provided. The undo function sends a request to undo the first computer implemented action to the second computer function. The undo function identifies itself with the same parameter that the first computer function used when requesting to perform the first computer implemented action (e.g., handler). Upon receiving the undo request, in order to completely undo the first computer implemented action and the subsequent computer implemented actions, the second computer function first determines what parameter corresponds to the undo function's parameter. The second computer function uses its mapping to identify the parameter that corresponds to the undo function's parameter. In this manner, each computer function should maintain an accurate mapping of the parameters and an accurate list of the subsequent actions performed as a result of the first computer implemented action because each computer implemented action is likely to be composite or interrelated with each other.

### SUMMARY

Described herein are implementations of various technologies for processing a computer implemented action. In one implementation, a computer function may first receive a request to perform a computer implemented action such as adding an email address to an email list server. In addition to receiving the request to perform the computer implemented action, the computer function may also receive an identification (ID) or parameter describing the ID of a computer or machine that may be sending the request. Upon receiving the request to perform the computer implemented action and the corresponding parameter, the computer function may create a new parameter to identify the sender of the request and send a request to composite computer functions to perform composite computer implemented actions. These composite computer implemented actions may include actions that may need to be performed in order to perform the original computer implemented action. After receiving the requests to perform the composite computer implemented actions, the composite computer functions may also create new parameters to identify the senders of the requests for composite computer implemented actions.

After the computer functions perform its requested computer implemented action, each computer function that performed the requested computer implemented action may send an object back to the computer function that sent the request to perform the requested computer implemented action. The object may be a first class representation of the computer implemented action that was performed by the corresponding computer function and the corresponding parameter that was used by the corresponding computer function. In this manner, an object may be created for each computer function that performs a computer implemented action. In one implementation, each of these objects may travel upstream back to the original computer function that requested the original computer implemented action. The original computer function may merge the received objects together to create a single object that is a first class representation of the composite computer implemented actions and their corresponding parameters.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a flow diagram of a conventional method for performing a computer action in accordance with one or more implementations of various techniques described herein.

FIG. 3 illustrates an example of a conventional method for undoing a computer action in accordance with one or more implementations of various techniques described herein.

FIG. 4 illustrates a flow diagram of a method for processing a computer action in accordance with one or more implementations of various techniques described herein.

FIG. 5 illustrates a schematic diagram a method for processing a computer action in accordance with one or more implementations of various techniques described herein.

FIGS. 6-7 illustrate examples of methods for performing a computer action and undoing the same computer action in accordance with one or more implementations of various techniques described herein.

### DETAILED DESCRIPTION

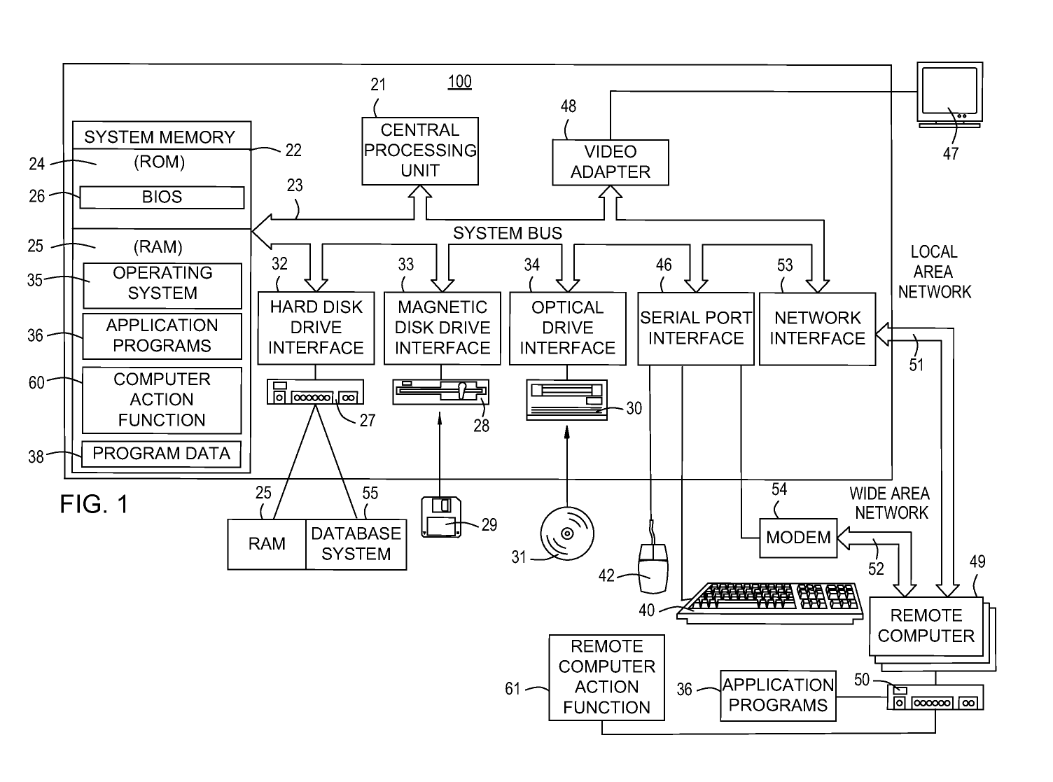

In general, one or more implementations described herein are directed to processing a computer action. Various techniques for processing a computer action will be described in more detail with reference to FIGS. 1-7.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

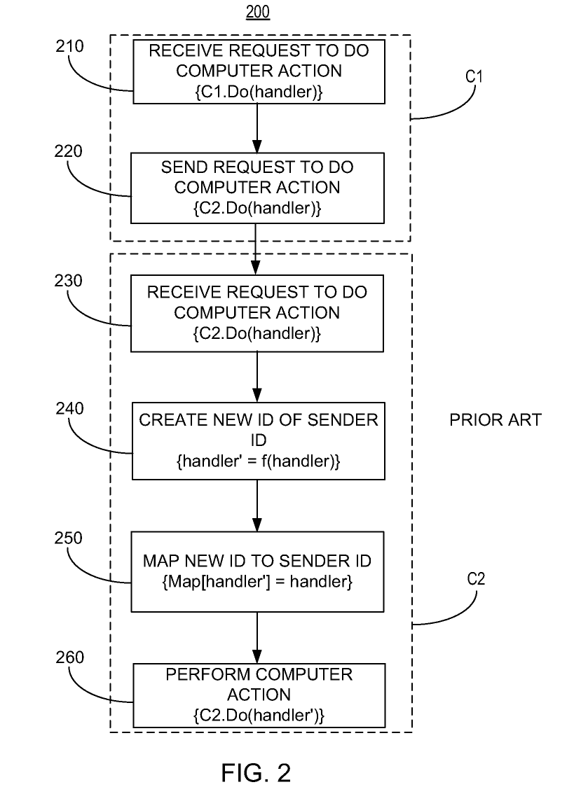

A number of program modules may be stored on the hard disk 27, magnetic disk 29, optical disk 31, ROM 24 or RAM 25, including an operating system 35, one or more application programs 36, a computer action function 60, program data 38, and a database system 55. The operating system 35 may be any suitable operating system that may control the operation of a networked personal or server computer, such as Windows® XP, Mac OS® X, Unix-variants (e.g., Linux® and BSD®), and the like. The computer action function 60 may be configured to perform a digital or computer action such as adding an email to a list server, placing an order for a product from an online merchant and the like. The computer action function 60 will be described in more detail with reference to FIGS. 2-7 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices such as speakers and printers.

Further, the computing system 100 may operate in a networked environment using logical connections to one or more remote computers 49. The logical connections may be any connection that is commonplace in offices, enterprise-wide computer networks, intranets, and the Internet, such as local area network (LAN) 51 and a wide area network (WAN) 52. The remote computers 49 may each include application programs 36 and a remote computer action function 61 similar to that of the computer action function 60. In one implementation, the computer action function 60 may invoke the remote computer action function 61 to perform a composite action. Additional details as to how the remote computer action function 61 may be used in relation to the computer action function 60 will be described in more detail with reference to FIGS. 2-7 in the paragraphs below.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

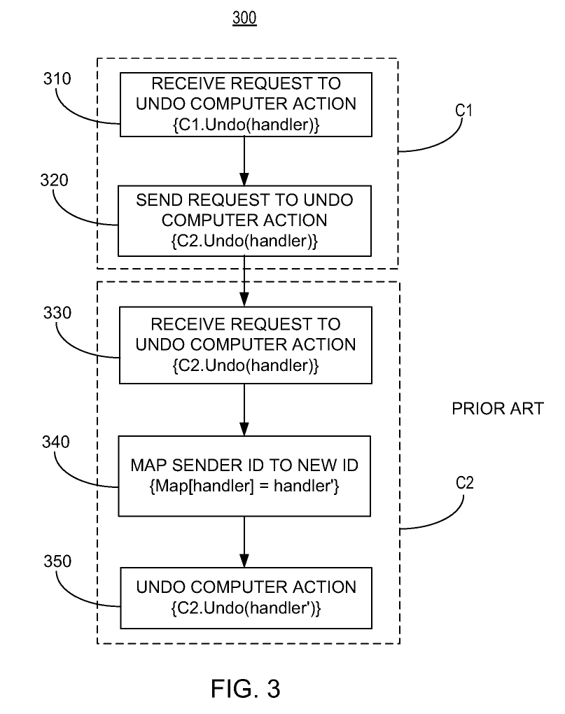

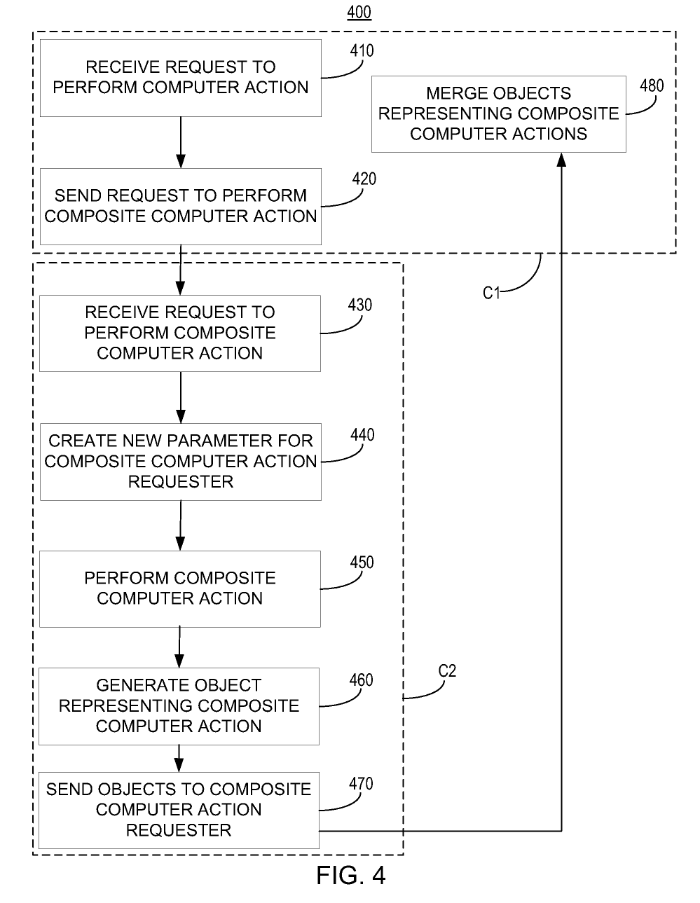

The following description of FIGS. 2-3 are provided to illustrate the conventional methods for performing a computer action and undoing the same computer action. The description of FIGS. 4-7 are then provided to illustrate a method for processing a computer action in accordance with one or more implementations of various techniques described herein.

FIG. 2 illustrates an example of a conventional method 200 for performing a computer action. The following description of method 200 is provided herein to explain how computer systems typically perform a computer action today. The following description of method 200 is made with reference to computing system 100 of FIG. 1. Method 200 is typically performed by the computer action function 60 and the remote computer action function 61 shown in FIG. 1. The computer implemented action can be any type of action performed by a computer, such as adding an email address to a list server, ordering a product from an online merchant, adding an event handler to an object or a Graphical User Interface (GUI) control, adding a listener to an asynchronous computation and the like. The steps illustrated in method 200 are typically performed by computer C1 or computer C2. Computer C1 includes the computer action function 60 and computer C2 includes the remote computer action function 61.

At step 210, the computer action function 60 on computer C1 receives a request to perform a computer action. The request to perform the computer action is represented by the following command: C1.Do(handler) where “C1” indicates the computer in which the command is directed towards, “Do” indicates the computer action to be performed and “handler” is a parameter that identifies computer C1. In order to perform the computer action, computer C1 needs to perform a composite action on computer C2. For example, if a computer manufacturer receives a request on computer C1 to perform a computer action, such as manufacture a laptop, the computer action function 60 in computer C1 consequently sends a request to a monitor manufacturer to send the computer manufacturer one monitor. Here, the computer action function 60 sends (see step 220) its request for one monitor to the remote computer action function 61 in computer C2 (e.g., remote computer 49).

At step 220, the computer action function 60 sends a request to perform a second computer action to the remote computer action function 61 on computer C2. The request for computer C2 to perform the second computer action is represented by the following command: C2.Do(handler) where “C2” indicates the computer in which the command is directed towards and the handler recited in the command is the parameter that identifies computer C1.

At step 230, the remote computer action function 61 receives the command requesting computer C2 to perform the second computer action. Upon receiving the request to perform the second computer action, at step 240, the remote computer action function 61 creates a new parameter to identify computer C1. The remote computer action function 61 creates the new parameter to maintain an internal record of computer C1's identity. The new parameter identifying computer C1 is defined by applying a function to the original parameter (i.e., handler′=f(handler)). In this manner, the remote computer action function 61 identifies computer C1 with the parameter “handler′”.

Using the example provided above, the monitor manufacturer receives a request to send one monitor to the computer manufacturer. The computer manufacturer identifies itself using the parameter: “Computer Manufacturer Inc.” However, the monitor manufacturer creates a customer number for each of its customers for its own internal records. As such, the monitor manufacturer creates a new parameter such as “Customer 0001” to identify the Computer Manufacturer Inc.

At step 250, the remote computer action function 61 maps the new parameter (handler′) created by the remote computer action function 61 for computer C1 to the original parameter (handler) provided by the computer action function 60. The mapping between the new parameter and the original parameter is defined as Map[handler′]=handler.

At step 260, the remote computer action function 61 performs the second computer action using the new parameter. As such, the remote computer action function 61 generates a command such as C2.Do(handler′) to perform the second computer action. Using the example provided above, the monitor manufacturer sends one monitor to the Customer 0001.

FIG. 3 illustrates an example of a conventional method 300 for undoing a computer action. The following description of method 300 is provided herein to explain how computer systems typically undo a computer implemented action today. The following description of method 300 is made with reference to computing system 100 of FIG. 1 and method 200 of FIG. 2. Method 300 for undoing the computer action is typically performed by the computer action function 60 and the remote computer action function 61. The computer action typically relates to any type of action that is performed on a computer or a microprocessor, such as adding an email address to a list server, ordering a product from an online merchant and the like. The steps illustrated in method 300 are performed on computer C1 or computer C2. Computer C1 includes the computer action function 60 and computer C2 includes the remote computer action function 61.

The computer action function 60 provides an undo function or application that is designed to undo a previous computer action. Using the example provided in reference to FIG. 2, the computer action function 60 at the computer manufacturer's computer provides a function to cancel the order for the laptop.

At step 310, the computer action function 60 receives a request to undo the computer action implemented in method 200 described in FIG. 2. The request to undo the computer action includes the original parameter provided to the computer action function 60 when it originally requested the computer action to be performed (e.g., step 210). In this manner, the command to undo the computer action is represented as C1.Undo(handler).

Since the computer action performed in method 200 of FIG. 2 caused the second computer action to take place in the remote computer action function 61, in order to completely undo the computer action, the computer action function 60 sends a request to the remote computer action function 61 to undo the second computer action. At step 320, the computer action function 60 sends the request to undo the second computer action to the remote computer action function 61. The computer action function 60 sends the original parameter (handler) to the remote computer action function 61 to identify itself. Using the example above, upon receiving the request to cancel the order for the laptop, the computer manufacturer then sends a request to the monitor manufacturer to cancel its order for one monitor. In its request to the cancel the order for one monitor, the computer manufacturer again identifies itself with the name “Computer Manufacturer Inc.”

At step 330, the remote computer action function 61 receives the request to undo the second computer action along with the original parameter. Upon receiving the request to undo the second computer action, at step 340, the remote computer action function 61 determines which of its created parameters correspond to the original parameter provided by the computer action function 60. In this manner, the remote computer action function 61 examines its mappings (i.e., Map[handler]=handler′) created at step 250 to identify the parameter that corresponds to the parameter provided by the computer action function 60. Using the example provided above, the monitor manufacturer examines its mappings to determine that “Computer Manufacturer Inc.” corresponds to “Customer 0001.”

At times, the remote computer action function 61 fails to create a mapping between the parameters. In this manner, upon receiving the request to undo the second computer action along with the original parameter, the remote computer action function 61 generates a new parameter for the original parameter. The new parameter does not correspond to the parameter created at step 250. As such, the remote computer action function 61 would not be able to accurately undo the second computer action. At other times, the mapping between the two parameters may be corrupted such that the mapping is no longer accurate. In this scenario, the remote computer action function 61 may undo a third computer action that may not be related to the second computer action.

At step 350, the remote computer action function 61 undoes the second computer action using the mapped parameter. The command for undoing the second computer action is represented as C2.Undo(handler′).

As shown above, the undo function provided by the computer action function 60 does not completely undo the composite actions that are related to the initial computer action. Further, if the initial request to perform the computer action provided at step 210 is made by an anonymous user, the undo function invoked at step 310 would not be able to accurately undo the composite action because it would not know which composite action relates to the requested computer action of the anonymous user. Even if the request to perform and undo the computer action is made by a known user having the same original parameter, each composite computer function needs to maintain a mapping between the original and new parameters in order to undo the appropriate computer action. These mappings complicate the undo function's performance and also lead to space overhead and possible memory leaks.

FIG. 4 illustrates a flow diagram of a method 400 for processing a computer implemented action in accordance with one or more implementations of various techniques described herein. The following description of method 400 is made with reference to computing system 100 of FIG. 1. It should be understood that while method 400 indicates a particular order of execution of the operations, in some implementations, certain portions of the operations might be executed in a different order. In one implementation, the method for processing a computer implemented action described in FIG. 4 may be performed by the computer action function 60 and the remote computer action function 61. Although the following description of method 400 is described as being performed by the computer action function 60 and the remote computer action function 61, it should be noted that method 400 is not limited to using only two different processors. Instead, method 400 may be performed by a computer function that invokes multiple composite computer functions within the same computer system or on multiple computer systems. Method 400 may also be performed by a single computer function based on composite events.

At step 410, the computer action function 60 may receive a request to perform a computer action. In addition to receiving the request to perform the computer action, the computer action function 60 may also receive a parameter identifying a computer, machine or user that may be sending the request.

At step 420, the computer action function 60 on computer C1 may invoke one or more composite computer functions to perform one or more composite computer actions. These composite computer actions may include actions that may be related to the original computer action. In some implementations, in order to perform the computer action requested at step 410, the computer action function 60 may need to invoke these composite computer actions. In order to invoke the composite computer function, the computer action function 60 may send a request to the remote computer function 61 on computer C2 to perform the composite computer action.

For example, if a computer manufacturer receives a request at the computer action function 60 to manufacture a laptop, the computer action function 60 may invoke a computer action function on a monitor manufacturer's computer system to send the computer manufacturer a monitor. Upon receiving the request for the monitor, the computer action function on the monitor manufacturer's computer system may invoke a computer action function on a power supply manufacturer's computer system to send a power supply to the monitor manufacturer. The subsequent computer actions that occur after the computer action function receives the initial request to manufacture a laptop are composite actions that are based on the request sent by the computer action function 60 to manufacture the laptop.

At step 430, the remote computer action function 61 may receive the request to perform the composite computer action along with a parameter identifying the computer action function 60. At step 440, the remote computer action function 61 may create a new parameter for the parameter it received at step 430. The new parameter may be created by the remote computer action function 61 according to the process described in step 240 of FIG. 2 above.

Using the example provided above, after receiving the request for a monitor from the computer action function, the computer action function at the monitor manufacturer's computer system may create a new parameter (handler′) to identify the computer action function. Here, the computer action function may have identified itself using the original parameter (e.g., handler). Similarly, after receiving the request for a power supply from the computer action function of the monitor's computer system, the computer action function at the power supply manufacturer's computer system may create a new parameter (handler″) to identify the computer action function of the monitor's computer system. Here, the computer action function of the monitor's computer system may have identified itself using the parameter (e.g., handler′) created by the computer action function of the monitor's computer system.

At step 450, the remote computer action function 61 may perform the composite computer action. Using the example provided above, the power supply manufacturer's computer system may send the power supply to the monitor manufacturer. Similarly, upon receiving the power supply, the monitor manufacturer's computer system may send the monitor to the computer manufacturer.

At step 460, the remote computer action function 61 may generate an object that may be a first class representation of the computer action performed by the remote computer action function 61. The object may also include information related to the parameter used by the remote computer action function 61 to perform the corresponding computer action. Using the example provided above, the computer action function on the power supply manufacturer's computer system may create an object describing the computer action of sending the power supply to the monitor manufacturer which may be identified in the object as handler″. Similarly, the computer action function on the monitor manufacturer's computer system may create an object describing the computer action of sending the monitor to the computer manufacturer which may be identified in the object as handler′.

At step 470, the object created by the remote computer action function 61 may be sent back to the computer action function 60. Using the example provided above, the computer action function on the power supply manufacturer's computer system may send its object describing the computer action, i.e., sending the power supply to the monitor manufacturer, to the computer action function on the monitor manufacturer's computer system. Similarly, the computer action function on the monitor manufacturer's computer system may send its object describing the computer action, i.e., sending the monitor to the computer manufacturer, to the computer action function on the computer manufacturer's computer system.

In one implementation, the computer action function 60 may send multiple requests to multiple composite computer functions to perform multiple composite computer actions at step 420. In this manner, steps 430-470 may be performed by each composite computer action function. When these composite computer actions send their objects to the computer action function 60 at step 470, the computer action function 60 may merge (step 480) all of the received objects together to create a single object that is a first class representation of all of the composite computer actions and their corresponding parameters.

In one implementation, the object may be used to undo the original computer action and all of the composite computer actions that occur as a result of the original computer action. Here, the object may be described as the inverse of the computer action function 60. In this manner, the object may be used to accurately and asynchronously undo all of the composite actions.

By having the object that is the inverse of the computer action, a programmer may no longer need to write separate computer action functions for performing a computer action and undoing the same computer action. For example, in the past, the programmer may write a computer function to perform a computer action (e.g., E.Do(handler)) and undo the computer action (e.g., E.Undo(handler)) as shown below.

Action<T> handler = x => Console.WriteLine(f(x));
E.Do(handler);
E.Undo(handler);

Instead, the programmer may just write a single computer function that may perform the computer action and output the object that represents the inverse of the computer action. An example of this computer function is shown below.

var undo = E.Do(x => Console.WriteLine(f(x)));
undo( );

In one implementation, the undo( ) computer function is output by the E.Do computer function where the undo( ) computer function performs the inverse of the computer action.

By outputting the inverse of the computer action function 60, method 400 has the advantage of clearly factoring the code into adding and removing the parameter created by the corresponding computer function instead of mapping the parameter to its corresponding parameter in the composite computer action function before calling the undo function. As such, method 400 may directly return the computer function that undoes the computer action and any composite computer action. For example, suppose that some event e1 exists and a second event e2 is defined in terms of e1 (i.e., e2 is a composite event based on event e1). The event e2 doesn't exist independently and requires the event e1 to raise events in order for the event e2 to raise its own events. In this sense, the event e1 is a real event and the event e2 is a proxy or composite event. So when a parameter is added to the event e1, the event e2 may subsequently compute a new parameter to add to the underlying event (e.g., event e2) based on the parameter added to the event e1. Using method 400 described above, the event e2 may then return a function which will undo the action of adding the new parameter to the event e2.

The general technique described in method 400 above calls for a “do” action to return the inverse of the “do” action. So if the action is named F, the inverse of action F may be an associated UndoF (the inverse, or undo function of F) function as shown below.

F :: X -> (A)
UndoF :: X -> (A')

Using method 400 described above, the action F may return the undo function instead as shown below.
F′::X→(X→(A′))
   In this manner, since the action F has access to the function X itself, there is no need to require the caller of the undo function to pass in the function X again.

F :: X -> (( ) -> ( ))
F(x) = let undo = F'(x)
in ( ) => undo(x)

In another implementation, the object may be used to redo the computer action again in the same manner as the original computer action may have been performed. In this implementation, since the object may describe each computer action performed at each composite computer function, redoing these computer actions may not require generating new parameters or waiting for each computer action function to invoke its composite computer action function. Instead, the composite computer actions may be performed asynchronously because the object may accurately indicate the composite computer action functions that may need to be invoked and their corresponding parameters that may be needed to perform the computer action again.

In yet another implementation, since the object may represent all of the composite computer actions that may have been invoked, the object may be used as a record of the composite computer actions that may have been performed by each computer action function. This record may be used as a receipt for a transaction or as proof of the composite computer actions as having been implemented.

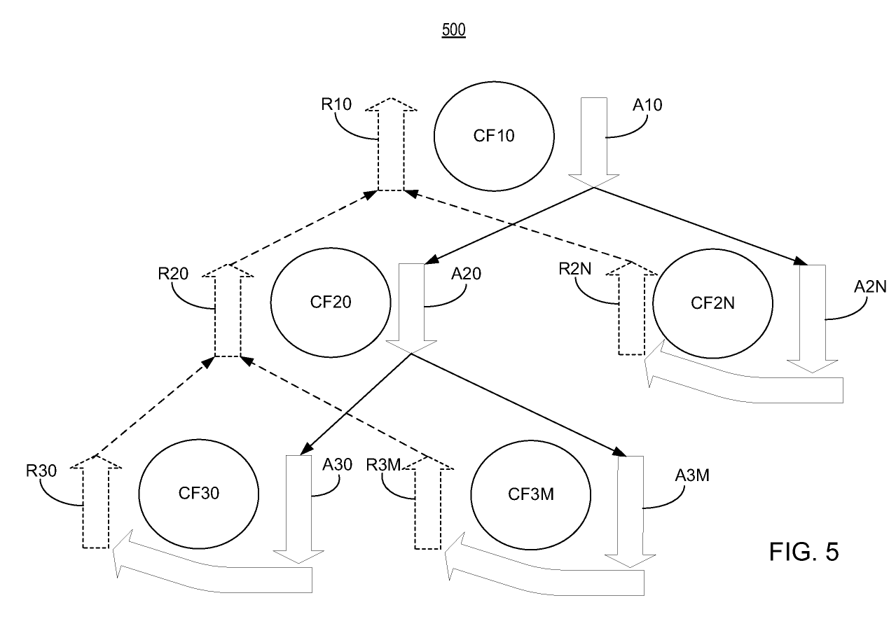

FIG. 5 illustrates a schematic diagram a method for processing a computer implemented action in accordance with one or more implementations of various techniques described herein. The following description of the schematic diagram 500 is made with reference to flow diagram 400 of FIG. 4. The schematic diagram 500 includes a number of computer functions (i.e., CF10, CF20, CF2N, CF30 and CF3M). In one implementation, computer function CF10 may perform a computer action A10. Computer action A10 may invoke computer action A20 and computer action A2N in computer function CF20 and computer function CF2N, respectively. In this manner, computer action A10 is described as:
Do(A10)=A20; A2N

After computer function CF20 receives the request to perform the computer action A20, computer action A20 may invoke computer action A30 and computer action A3M. In this manner, computer action A20 is described as:
Do(A20)=A30; A3M

However, after computer function CF2N receives the request to perform computer action A2N, computer function CF2N may perform computer action A2N and output a return function R2N that may describe computer action A2N performed at computer function CF2N. In this manner, return function R2N may be described as:
R2N=Do(A2N)

After outputting return function R2N, computer function CF2N may send return function R2N back to computer function CF10 as a first class representation of computer action A2N.

Similarly, after computer function CF30 and computer function CF3M receive the request to perform computer action A30 and computer action A3M, each computer function may output a return function that may describe the corresponding computer action. In this manner, return function R30 and return function R3M may be described as:
R30=Do(A30)
R3M=Do(A3M)

After outputting return function R30 and return function R3M, computer function CF30 and computer function CF3M may send return function R30 and return function R3M back to computer function CF20 as a first class representation of computer action A30 and computer action A3M, respectively. After receiving return function R30 and return function R3M, computer function CF20 may merge these return functions together to form one return function R20, which may be a first class representation of computer action A20 that may consequently represent computer action A30 and computer action A3M. In this manner, return function R20 is described as:
R20=Do(R30; R3M)

The computer function CF20 may then send the return function upstream to computer function CF10. Upon receiving return function R20 and return function R2N, computer function CF10 may merge these return functions together to form one return function R10, which may be a first class representation of computer action A20 and computer action A2N. In this manner, return function R10 is described as:
R10=Do(R20; R2N)

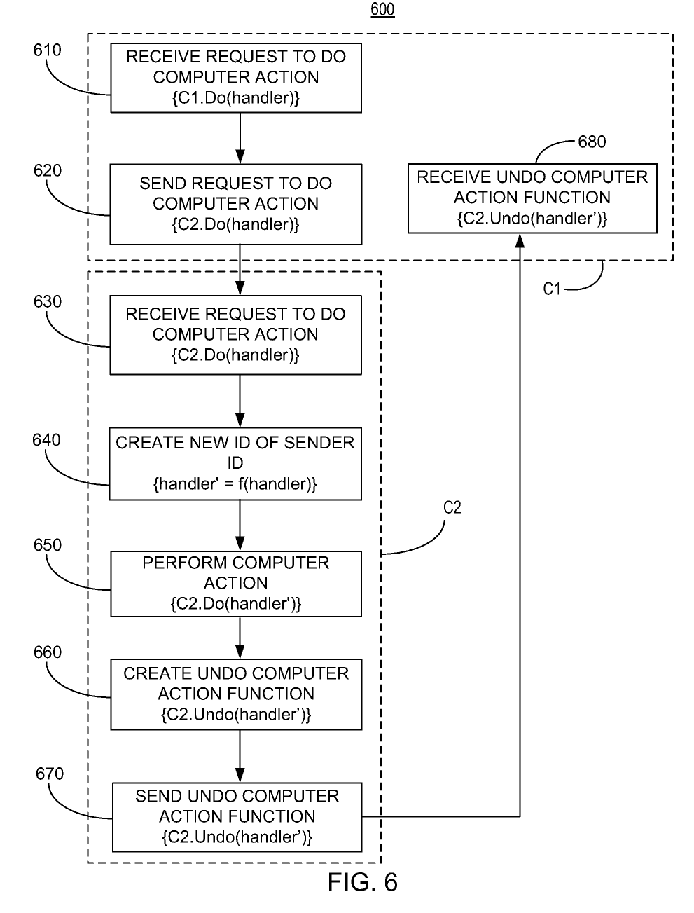

FIG. 6 illustrates an example of a method 600 for performing a computer implemented action and undoing the same computer implemented action in accordance with one or more implementations of various techniques described herein. The following description of method 600 is made with reference to method 200 of FIG. 2 and method 400 of FIG. 4. It should be understood that while the operational flow of method 600 indicates a particular order of execution of the operations, in some implementations, certain portions of the operations might be executed in a different order. In one implementation, method 600 may be performed by the computer action function 60 and the remote computer action function 61.

In one implementation, steps 610-640 may correspond to steps 210-240 as described in FIG. 2. However, instead of mapping the new parameter (handler′) created by the remote computer action function 61 for the computer C1 to the original parameter (handler) provided by the computer action function 60 (i.e., step 250), at step 650, the remote computer action function 61 may perform the second computer action using the new parameter. As such, the remote computer action function 61 may generate a command such as C2.Do(handler′) to perform the second computer action.

At step 660, the remote computer action function 61 may generate an undo computer action function (e.g., C2.Undo(handler′)), which may be a first class representation of the inverse of the computer action performed by the remote computer action function 61 at step 650. The undo computer action function may also include information related to the parameter (e.g., handler′) used by the remote computer action function 61 to perform the corresponding computer action. In one implementation, step 660 may correspond to step 460 in method 400 described of FIG. 4.

At step 670, the remote computer action function 61 may send the undo computer action function back to the computer action function 60 which may correspond to step 470 in method 400 of FIG. 4. At step 680, the computer action function 60 may receive the undo computer action function. In one implementation, the undo computer action function may be stored in the hard disk drive 27 or another memory component in the computing system 100.

Using the example provided in FIG. 2, if a computer manufacturer receives a request on the computer action function 60 to perform a computer action such as, manufacture a laptop, the computer action function 60 may consequently send a request to a monitor manufacturer to send the computer manufacturer one monitor. Here, the computer action function 60 may send (see step 620) its request for one monitor to the remote computer action function 61. The monitor manufacturer may receive the request to send one monitor to the computer manufacturer, and the request may identify the computer manufacturer by its name “Computer Manufacturer Inc.” (see step 630). The monitor manufacturer may then create a new parameter such as “Customer 0001” to identify the Computer Manufacturer Inc. (see step 640). After performing the computer action (i.e., sending the monitor; step 650), the remote computer function 61 may create an undo computer action function (i.e., 660). The undo computer action function may send a notification to the monitor manufacturing to cancel the order for the monitor. In one implementation, the undo computer action function may include information pertaining to the action (i.e., cancel order for monitor) performed by the remote computer function 61 and the parameter (i.e., Customer 0001) created by the remote computer function 61. In this manner, when the undo computer action function is invoked, the monitor manufacturer's remote computer action function 61 may receive a command (i.e., C2.Undo(handler′)) to cancel the order for the monitor with respect to Customer 0001.

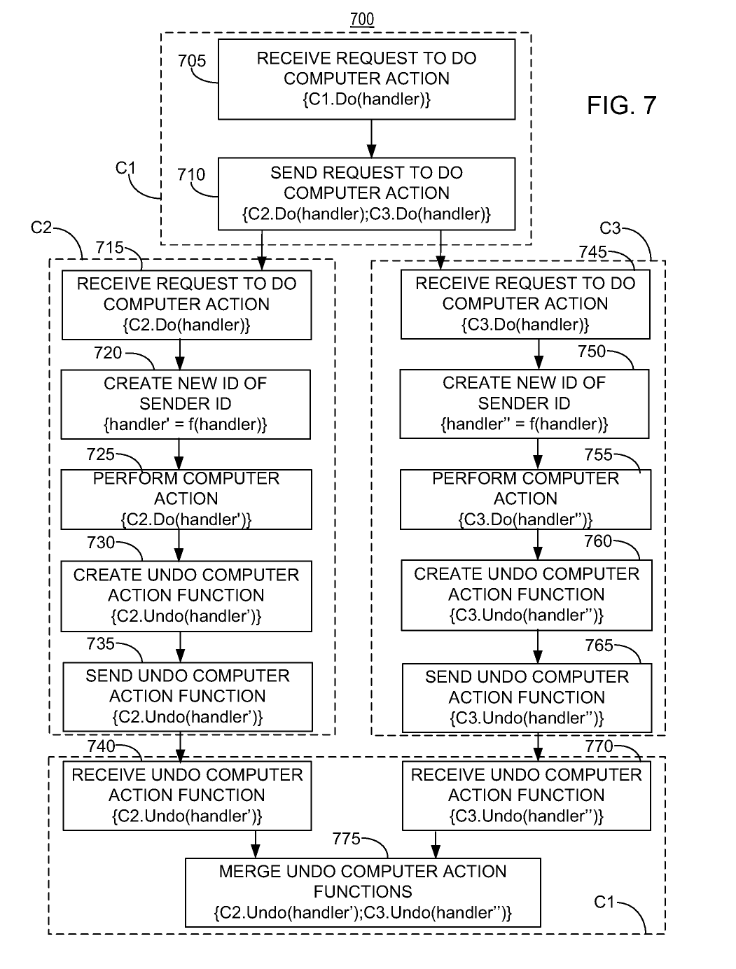

FIG. 7 illustrates an example of a method for performing a computer action and undoing the same computer action in accordance with one or more implementations of various techniques described herein. The following description of the flow diagram 700 is made with reference to method 200 of FIG. 2 and method 400 of FIG. 4. It should be understood that while the operational flow diagram of method 700 indicates a particular order of execution of the operations, in some implementations, certain portions of the operations might be executed in a different order. In one implementation, the method for performing a computer action and undoing the same computer action described in FIG. 7 may be performed by the computer action function 60 on the computer C1, the remote computer action function 61 on the computer C2 and the remote computer action function 61′ on the computer C3.

At step 705, the computer action function 60 on the computer C1 may receive a request to do or perform a computer action. In one implementation, the request to perform the computer action may be represented by the following command: C1.Do(handler). The handler recited in the command may be a parameter that may identify the computer C1.

In one implementation, the request to perform the first computer action may require a composite computer action to be performed on the computer C2 and the computer C3. In this manner, at step 710, the computer action function 60 may send a request to the remote computer action function 61 on the computer C2 to perform a second computer action. The computer action function 60 may also send a request to the remote computer action function 61′ on the computer C3 to perform a third computer action.

At step 715, the remote computer action function 61 may receive the command requesting the computer C2 to perform the second computer action. Upon receiving the request to perform the second computer action, at step 720, the remote computer action function 61 may create a new parameter to identify the computer C1. In one implementation, the remote computer action function 61 may create the new parameter to maintain an internal record of the identity of the computer C1. The new parameter identifying the computer C1 may be defined by applying a function to the original parameter (i.e., handler′=f(handler)). In this manner, the remote computer action function 61 may identify the computer C1 with the parameter “handler”.

At step 725, the remote computer action function 61 may perform the second computer action using the new parameter. As such, the remote computer action function 61 may generate a command such as C2.Do(handler′) to perform the second computer action.

At step 730, the remote computer action function 61 may generate an undo computer action function (e.g., C2.Undo(handler′)) that may be a first class representation of the inverse of the computer action performed by the remote computer action function 61 at step 725. The undo computer action function may also include information related to the parameter (e.g., handler′) used by the remote computer action function 61 to perform the corresponding computer action. In one implementation, step 730 may correspond to step 460 in method 400 described of FIG. 4.

At step 735, the remote computer action function 61 may send the undo computer action function back to the computer action function 60 on the computer C1 which may correspond to step 470 in method 400 of FIG. 4. At step 740, the computer action function 60 may receive the undo computer action function. In one implementation, the undo computer action function may be stored in the hard disk drive 27 or another memory component in the computing system 100.

Steps 745-770 may correspond to the steps 715-740. Steps 715-740, however, may be performed by the remote computer action application 61′ on the computer C3. As such, at step 750, the remote computer action application 61′ may create a new parameter to identify the computer C1. In one implementation, the remote computer action function 61 may create the new parameter to maintain an internal record of the identity of the computer C1. The new parameter identifying the computer C1 may be defined by applying a function to the original parameter (i.e., handler″=f(handler)). In this manner, the remote computer action function 61 may identify the computer C1 with the parameter handler″. As shown in step 750, the parameter generated by the remote computer action application 61″ may be different from the parameter created by the remote computer action application 61 as described in step 720. In this manner, the undo function created by the remote computer action application 61′ created at step 760 should be specifically related to the parameter (handler″) created by the remote computer action application 61′ on the computer C3. The undo computer action function created at step 760 may be defined as C3.Undo(handler″).

After receiving the undo computer action functions from the remote computer action function 61 and the remote computer action function 61′, at step 775, the computer action function 60 may merge the two received undo computer functions. The merged undo computer functions may be described as {C2.Undo(handle′);C3.Undo(handler″)}.

By outputting the undo computer action functions, the parameter itself does not need to be recalculated when the computer actions are undone. Therefore, each of the n computer actions returns an undo function, and each undo function is merged together. The computer action application 60 may then return one remote function, which invokes the inverse of the n computer actions. This method of returning the inverse function may generalize the command design pattern a functional rather than object-oriented way.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for processing a computer action using a processor, comprising:
receiving a first request to perform a first computer action;
performing the first computer action; and
producing a first class representation of the first computer action.

2. The method of claim 1, wherein the first class representation of the first computer action comprises the first computer action and a parameter that corresponds to the first computer action.

3. The method of claim 1, wherein performing the first computer action comprises:
sending a second request to perform a second computer action based on the first computer action; and
receiving a first class representation of the second computer action.

4. The method of claim 1, wherein the first computer action comprises:
adding an email address to a list server;
purchasing an item from a merchant;
adding an event handler to an object or a Graphical User Interface (GUI) control;
adding a listener to an asynchronous computation; or
combinations thereof.

5. The method of claim 3, wherein sending the second request comprises sending a parameter that corresponds to the first computer action.

6. The method of claim 3, wherein the first class representation of the second computer action comprises the second computer action and a first parameter that corresponds to the second computer action.

7. The method of claim 6, wherein the first class representation of the first computer action comprises the first computer action, a second parameter that corresponds to the first computer action and the first class representation of the second computer action.

8. The method of claim 1, wherein the first class representation of the first computer action is used to undo or redo the first computer action.

9. The method of claim 3, wherein the first class representation of the second computer action comprises the second computer action, a first parameter that corresponds to the second computer action, a third computer action and a second parameter that corresponds to the third computer action merged together.

10. A computer system, comprising:
a first processor;
a second processor; and
a first memory comprising program instructions executable by the first processor to:
receive a first request to perform a first computer action;
perform the first computer action; and
return a first class representation of the first computer action.

11. The computer system of claim 10, wherein the program instructions executable by the first processor to perform the first computer action comprises program instructions to:
send a second request to the second processor to perform a second computer action based on the first computer action; and
send a first parameter to the second processor, wherein the first parameter identifies the first processor.

12. The computer system of claim 11, further comprising a second memory comprising program instructions executable by the second processor to:
receive the second request and the first parameter from the first processor;
generate a second parameter that corresponds to the first parameter; and
perform the second computer action using the second parameter.

13. The computer system of claim 12, further comprising the second memory comprising program instructions executable by the second processor to:
create a first class representation of the second computer action; and
send the first class representation of the second computer action to the first processor.

14. The computer system of claim 13, wherein the first class representation of the first computer action comprises the first computer action, the first parameter, and the first class representation of the second computer action.

15. The computer system of claim 13, wherein the first class representation of the second computer action comprises the second computer action and the second parameter.

16. The computer system of claim 12, wherein the first memory further comprises program instructions, executable by the first processor, to send an undo command to the second processor, wherein the undo command comprises information related to the second parameter and the second computer action.

17. A computer system, comprising:
a first processor;
a second processor;
a third processor; and
a first memory comprising program instructions executable by the first processor to:
receive a first request to perform a first computer action;
send a second request to the second processor to perform a second computer action based on the first computer action;
send a third request to the third processor to perform a third computer action based on the first computer action; and
send a first parameter to the second processor and the third processor, wherein the first parameter identifies the first processor;
return a first class representation of the first computer action.

18. The computer system of claim 17, further comprising:
a second memory comprising program instructions executable by the second processor to:
receive the second request and the first parameter from the first processor;
generate a second parameter that corresponds to the first parameter;
perform the second computer action using the second parameter;
send a first class representation of the second computer action to the first processor;
a third memory comprising program instructions executable by the third processor to:
receive the third request and the first parameter from the first processor;
generate a third parameter that corresponds to the first parameter;
perform the third computer action using the third parameter; and
send a first class representation of the third computer action to the first processor.

19. The computer system of claim 18, wherein the program instructions executable by the first processor to return the first class representation of the first computer action comprises program instructions to:
receive the first class representation of the second computer action from the second processor;
receive the first class representation of the third computer action from the third processor; and
merge the first class representation of the second computer action and the first class representation of the third computer action together to create the first class representation of the first computer action.

20. The computer system of claim 17, wherein the first class representation of the first computer action is a record of the first computer action, the second computer action and the third computer action.
